(19) United States
(12) Patent Application Publication
(10) Pub. No.: US 2024/0413577 A1
(43) Pub. Date: Dec. 12, 2024

(54) SECURING DEVICE HAVING AN IDENTIFYING FEATURE VISIBLE IN FIELDS OF VIEW

(71) Applicant: Lisa Dräxlmaier GmbH, Vilsbiburg (DE)

(72) Inventors: Stefan WIMMER, Hohenthann (DE); Sebastian WILHELM, Schmelz (DE); Franziska NEUMAYER, Geisenhausen (DE)

(73) Assignee: Lisa Dräxlmaier GmbH, Vilsbiburg (DE)

(21) Appl. No.: 18/735,615

(22) Filed: Jun. 6, 2024

(30) Foreign Application Priority Data
Jun. 6, 2023 (DE) 102023114788.9

(51) Int. Cl. H01R 13/631; H01R 13/629; H01R 13/641

(52) U.S. Cl. CPC H01R 13/631; H01R 13/62933; H01R 13/641

(57) ABSTRACT

A securing device for securing the locking of a locking element including a locking element, which can be moved from a first locking position into a second locking position. The locking element produces locking in the second locking position. The securing device further includes an indicator element including an identifying feature for indicating an item of information. In the first locking position of the locking element, the identifying feature is visible within a first field of view. In the second locking position of the locking element, the identifying feature is visible within a second field of view.

### CROSS-REFERENCE TO RELATED APPLICATIONS

This application claims priority to and the benefit of DE 10 2023 114 788.9 filed on Jun. 6, 2023. The disclosure of the above-referenced application is incorporated herein by reference.

### FIELD

The present disclosure relates to a securing device to secure the locking of a locking element.

### BACKGROUND

The statements in this section merely provide background information related to the present disclosure and may not constitute prior art.

CPA (connector position assurance) is intended to inhibit a connector housing latched to a mating connector housing from being inadvertently detached from the mating connector housing, as can happen for example due to vibrations, temperature-related expansion or shrinkage, pulling on a cable accommodated in the connector housing, or other mechanical effects. For this, the CPA system is responsible for locking the connector to its mating connector, as the last element to be operated. In order to provide secure locking here, it is desired for the final state of the locking to be detected by virtue of a scannable element and for this element to be readable when the CPA system is finally closed.

### SUMMARY

This section provides a general summary of the disclosure and is not a comprehensive disclosure of its full scope or all of its features.

The present disclosure relates to a securing device having an identifying feature which is visible in a first field of view and in a second field of view. The securing device serves to secure the locking of a locking element or for connector position assurance (CPA) and can be used to secure the locking of a connector housing to a mating connector housing. In particular, the present disclosure relates to a CPA system having an identifying feature, the reading direction of which is controlled. The identifying feature may be a code, for example a DMC (data matrix code).

The present disclosure provides a suitable device which makes it possible to reliably discern if locking is present or not, in particular for connectors for which CPA locking is desired.

The connector may have a high degree of automation in terms of production and fabrication makes the use of a scannable element desired as an assurance function. The present disclosure presented here relates to a securing device including an indicator element having an identifying feature, which is visible in a first field of view or in a second field of view depending on the locking state of the locking element. A reading element which is positioned within the second field of view and outside the first field of view can thus reliably indicate the locking of the locking element since the item of information indicated by the indicator element is discernible only in the second field of view. Here, in both of the locking positions, the identifying feature is not concealed and always remains visible. The indicator element can thus be used as a scannable element to provide reliable assurance of the connector mounting and make it possible to scan the plug system in the assembled state. The present disclosure presented here can be applied to various plug systems and can be easily adapted from one plug system to another plug system.

The basic principle of one example of the present disclosure is the control of the reading direction of a scannable element (referred to as DMC in the following text). The DMC is positioned such that the DMC is visible, but only from a certain angle, and therefore the DMC is not concealed. The DMC is discernible in an inconvenient position, and thus not from above. Actuating the CPA system enhances the reading direction and makes the DMC discernible from various angles.

The main feature of this example is the control of the detectability by manipulating the reading direction. The DMC is discernible only from a first position and only from a certain direction. In a second position, the DMC is discernible from a different direction.

According to a first aspect, the present disclosure provides a securing device for securing the locking of a locking element, wherein the securing device includes the following: a locking element, which can be moved from a first locking position into a second locking position, wherein the locking element produces locking in the second locking position; an indicator element having an identifying feature for indicating an item of information; wherein, in the first locking position of the locking element, the identifying feature is visible within a first field of view; and wherein, in the second locking position of the locking element, the identifying feature is visible within a second field of view.

The item of information may be any desired item of information. In particular, the item of information is an item of information regarding locking or non-locking by the locking element. The item of information may additionally also contain other things, for example user information, serial number of the securing device or of individual components of the device, instructions for the user, etc.

Such a securing device affords the technical advantage that it is possible to securely and reliably discern locking. The indicator element having the identifying feature can be detected via a detecting element, for example a reading element or a scannable element, which is placed in the second field of view, for example above the indicator element, so that it is possible to reliably automatically discern the item of information and thus a position of the locking element. This also makes it possible to automatically detect the state of connectors for which CPA locking is desired. The securing device thus meets the standards for CPA locking.

The identifying feature may, for example, be a code, for example a one- or multi-dimensional code, or a pictogram or a symbol.

In this instance, the second field of view may be a field of view in which a detecting element designed to detect or discern the identifying feature is positioned.

The second field of view may include, for example, a larger viewing area than the first field of view.

According to an example of the securing device, in both of the locking positions of the locking element, the identifying feature is not concealed and always remains visible.

This affords the technical advantage that covering the indicator element having the identifying feature to achieve the desired effect of non-discernibility may be omitted. The modification of the viewing area from a first field of view to a second field of view is already sufficient to make the identifying feature unrecognizable, so that the identifying feature cannot be detected or discerned by an identifying element, for example a reading element or a scannable element placed in a certain position with respect to the indicator element. The identifying element or scannable element can then detect the item of information only in the second locking position, but not in the first locking position.

According to an example of the securing device, the first field of view and the second field of view include different viewing areas.

This can provide that, in a predefined arrangement of the detecting element and/or reading element or scannable element, the item of information can only be detected if the locking element is in the second locking position, which is to say locking is present.

According to an example of the securing device, the securing device includes a manipulation element, which is designed to change the first field of view to the second field of view when the locking element is being moved from the first locking position to the second locking position.

This affords the technical advantage that it is possible to change between the two fields of view via a straightforward manipulation element. The manipulation element is mechanically coupled to the locking element and, depending on the movement of the locking element, changes the first field of view to the second field of view, or vice versa.

According to an example of the securing device, the manipulation element is designed to modify a reading direction, in which the identifying feature can be discerned, when the locking element is being moved from the first locking position to the second locking position.

This affords the technical advantage that changing the reading direction makes it possible to predefine the position at which an identifying element, for example a reading element, may be placed in order that the reading element can detect or read the item of information of the identifying feature on the indicator element in the second locking position, which is to say when locking is present, and cannot discern the item of information in the first locking position.

According to an example of the securing device, the indicator element includes an indication plane and is designed to depict the identifying feature on the indication plane; wherein the identifying feature is discernible within a first range of reading angles with respect to the indication plane in the first locking position; and wherein the first range of reading angles does not include a right angle to the indication plane.

This affords the technical advantage that the identifying feature is not discernible from above, which is to say perpendicularly to the indication plane, in the first locking position, since the first range of reading angles does not include a right angle.

It is evident that the first range of reading angles not only does not include exactly a right angle, which is to say an angle of 90° to the indication plane, but also does not include any angle which is approximately a right angle, for example reading angles ranging from 89° to 91° or ranging from 88° to 92° or ranging from 85° to 95° or ranging from 80° to 100° or ranging from 70° to 110° or a range of reading angles which is not symmetrical around 90°.

According to an example of the securing device, the identifying feature is discernible within a second range of reading angles with respect to the indication plane in the second locking position; wherein the second range of reading angles includes a right angle to the indication plane.

This affords the technical advantage that the identifying feature is discernible from above, which is to say perpendicularly to the indication plane, in the second locking position, since the second range of reading angles includes a right angle.

According to an example of the securing device, the first range of reading angles and the second range of reading angles do not include a common angle.

This affords the technical advantage that it is clearly possible to make a spatial distinction between the first locking position and the second locking position. An identifying element placed in a spatial position in which the identifying element is at a reading angle from the second range of reading angles to the indication plane discerns the identifying feature in the second locking position but not in the first locking position.

According to an example of the securing device, the identifying feature includes a code designed to indicate the item of information; wherein the code is discernible within the first field of view in the first locking position; and wherein the code is discernible within the second field of view in the second locking position.

This affords the technical advantage that it is easily possible to be able to make a distinction on the basis of codes. Codes suitable for this, such as 1D, 2D or 3D codes, have a strong contrast, so that they can be discerned by an identifying element placed in the first field of view or in the second field of view.

For example, the code may be a one-dimensional or multi-dimensional code, for example a data matrix code, DMC, or a QR code or a barcode.

The data matrix code is one of the best known 2D codes and can be used for permanent and robust direct labelling. The DMC is variable in size and thus permits a multiplicity of symbol elements. QR codes and barcodes are also well suited as identifying feature.

According to an example of the securing device, the securing device is designed to perform connector position assurance (CPA) to secure the locking of a connector housing to a mating connector housing.

This affords the technical advantage that the state of the CPA system can be reliably detected by virtue of an identifying element or scannable element, which is readable only when the CPA system is finally closed.

According to an example of the securing device, the securing device also includes: a clamping element for clamping the connector housing into the mating connector housing, wherein the clamping element can be moved from an open clamping-element position, in which the connector housing can be inserted into the mating connector housing, into a closed clamping-element position, in which the connector housing is fastened to the mating connector housing with electrical contact; wherein the locking element is placed on the clamping element and designed to lock or to unlock the clamping element. As already described above, the indicator element indicates an item of information, for example an item of information about the locking of the clamping element by the locking element.

This affords the technical advantage that the indicator element reliably indicates an item of information, for example an item of information regarding the locking of the clamping element, for example a clip, so that the state of the clamping element can be reliably discerned, for example by way of a scannable element. As already mentioned above, the item of information may also be any other type of information. When the information is discernible, locking is present.

According to an example of the securing device, in the closed clamping-element position, the locking element can be moved from the first locking position into the second locking position and is designed, in the second locking position, to lock the clamping element in the closed clamping-element position and, in the first locking position, to unlock the clamping element for a movement into the open clamping-element position.

This affords the technical advantage that a secure connection of the connector housing to the mating connector housing via the clamping element is provided. The securing device thus meets the standards for CPA locking.

According to an example of the securing device, the indicator element and the manipulation element are placed on the clamping element.

This affords the technical advantage that the indicator element can reliably and robustly indicate an item of information, for example an item of information regarding locking. The manipulation element may have a straightforward structure, in order to change the first field of view to the second field of view, and vice versa, when the locking element is being moved from the first locking position to the second locking position, since the locking element, the indicator element and also the manipulation element are placed on the same component, which is to say the clamping element.

According to a second aspect, the present disclosure provides a plug connection having a connector housing and a mating connector housing, which are connected to one another and secured by a securing device according to the first aspect.

According to a third aspect, the present disclosure provides a securing system including a securing device according to the first aspect and a reader, wherein the reader is designed to detect the identifying feature of the indicator element when the locking element is in the second locking position, in order to discern an item of information, for example an item of information about the locking.

According to an example of the securing system, the reader is placed in the second field of view and designed to detect the identifying feature of the indicator element when the locking element is in the second locking position and to detect correct locking in this position.

According to a fourth aspect, the present disclosure provides a method for securing the locking of a locking element, wherein the method includes the following steps: moving a locking element from a first locking position into a second locking position, wherein, in the second locking position, the locking element produces locking; indicating an item of information via an indicator element having an identifying feature; wherein, in the first locking position of the locking element, the identifying feature is visible within a first field of view; and wherein, in the second locking position of the locking element, the identifying feature is visible within a second field of view.

Such a method affords the same technical advantages as the securing device described above according to the first aspect.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a schematic illustration of the states of a securing device according to the present disclosure;

FIG. 2A shows an illustration of a securing device according to the present disclosure as per one example in the first locking position, in which the identifying feature is not discernible in the second field of view, in this case from above;

FIG. 2B shows an illustration of the securing device according to the present disclosure from FIG. 2A in the second locking position, in which the identifying feature is discernible in the second field of view, in this case from above;

FIG. 3A shows a cross-sectional illustration of the securing device according to the present disclosure as per one example in the first locking position, in which the identifying feature is discernible in the first field of view;

FIG. 3B shows a cross-sectional illustration of the securing device according to the present disclosure as per one example in the second locking position, in which the identifying feature is discernible in the second field of view;

FIG. 4A shows a cross-sectional illustration of the securing device according to the present disclosure as per one example in the first locking position, at a reading angle of approximately 70°;

FIG. 4B shows a perspective view of the securing device according to the present disclosure from FIG. 4A looking towards the identifying feature parallel to the reading direction; and

FIG. 5 shows a perspective view of a securing device including a locking element, an indicator element having an identifying feature and a clamping element in a closed clamping-clip position, in which the locking element is in the second locking position.

The figures are merely schematic illustrations and serve only to explain the present disclosure. Elements that are the same or have the same effect are provided with the same reference signs throughout.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the detailed description that follows, reference is made to the accompanying drawings, which form a part thereof and which show, as an illustration, specific examples in which the present disclosure can be carried out. It goes without saying that other examples can also be used and structural or logical changes can be made without departing from the concept of the present disclosure. The detailed description that follows should therefore not be understood in a restrictive sense. It also goes without saying that the features of the various examples described herein can be combined with one another unless specifically stated otherwise.

The aspects and examples are described with reference to the drawings, wherein reference signs that are the same generally relate to the same elements. Numerous specific details are set out for the purposes of explanation in the description that follows in order to provide an in-depth understanding of one or more aspects of the present disclosure. However, it may be obvious to a person skilled in the art that one or more aspects or examples can be implemented with a lesser degree of the specific details. In other cases, known structures and elements are illustrated in a schematic form in order to make it easier to describe one or more aspects or examples. It goes without saying that other examples can be used and structural or logical changes can be made without departing from the concept of the present disclosure.

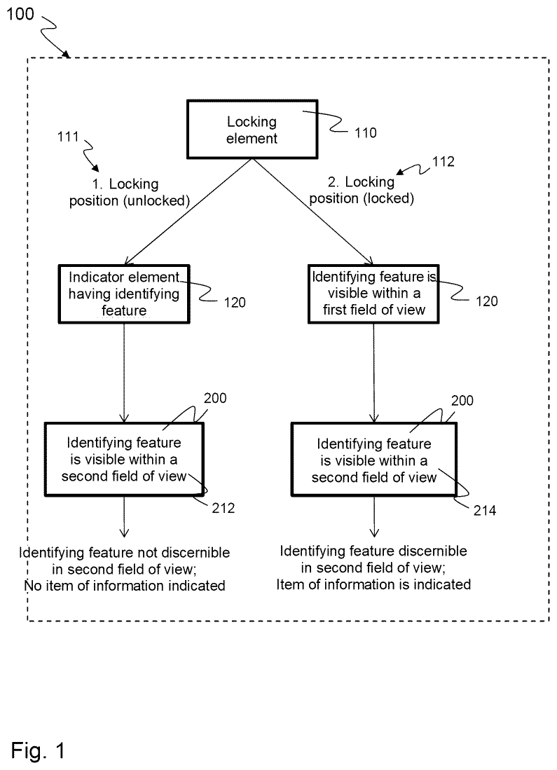

FIG. 1 shows a schematic illustration of the states of a securing device 100 according to the present disclosure.

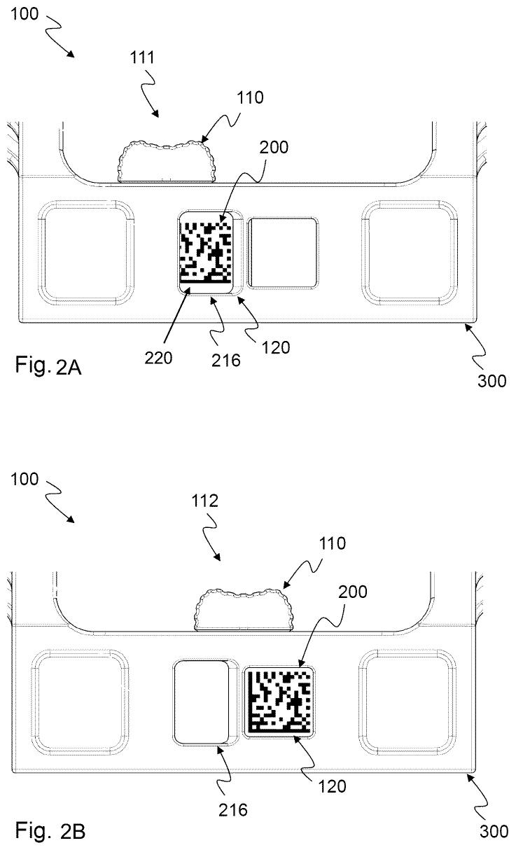

The securing device 100 serves to secure the locking of a locking element 110. The securing device 100 includes a locking element 110 and an indicator element 120 having an identifying feature 200 (see also FIGS. 2A and 2B, 3A and 3B, and 4A and 4B).

The locking element 110 can be moved from a first locking position 111 into a second locking position 112 and produces locking in the second locking position 112.

The indicator element 120 having the identifying feature 200 serves to indicate an item of information, for example an item of information about the locking by the locking element 110 or another item of information, for example a pictogram or a symbol, etc.

In the first locking position 111 of the locking element 110, the identifying feature 200 is visible within a first field of view 212. In the second locking position 112 of the locking element 110, the identifying feature 200 is visible within a second field of view, for example via an identifying element such as a scannable element, which is positioned within the second field of view.

In both of the locking positions 111, 112 of the locking element 110, the identifying feature 200 is not concealed and always remains visible, as set out in more detail below in relation to FIGS. 2A and 2B, 3A and 3B, and 4A and 4B.

An example of the identifying feature 200, which is visible in the first field of view or in the second field of view depending on the locking position, is illustrated and described in more detail in FIGS. 2A and 2B, 3A and 3B, and 4A and 4B.

FIGS. 2A and 2B show illustrations of a securing device 100 according to the present disclosure as per one example in the first locking position 111, in which the identifying feature 200 is not discernible in the second field of view 214, in this case from above, and in the second locking position 112, in which the identifying feature 200 is discernible in the second field of view 214.

The main focus of this approach is to control the reading direction of a scannable element, in this case the indicator element 120 having the identifying feature 200. The identifying feature 200, for example a code 201, is visible in any position of the CPA system or the locking element 110, but is visible only from a certain angle in the first locking position 111, as illustrated in FIG. 2A, in order to inhibit scanning from above.

FIG. 2A shows the CPA system or the locking element 110 in the open state from above. In the open state of the locking element 110 or the CPA system, the identifying feature, for example a code 201, for example a data matrix code (DMC), cannot be read from above. FIG. 2B shows the closed CPA system or the locking element 110 in the second locking position 112. In the closed state, the identifying feature 200, for example the code 201, e.g. the DMC, can be read from above, since the reading direction was changed by a displacement. Scanning is now possible from various sides.

The securing device 100 in FIG. 2A and FIG. 2B corresponds to the securing device described above in relation to FIG. 1, with FIG. 2A and FIG. 2B illustrating the structure of this securing device 100 in more detail.

As already described above in relation to FIG. 1, the securing device 100 serves to secure the locking of a locking element 110. The securing device 100 includes a locking element 110 and an indicator element 120 having an identifying feature 200, which is visible within the first field of view 212 or within the second field of view 214 depending on the locking position.

The locking element 110 can be moved from a first locking position 111 into a second locking position 112 and produces locking in the second locking position 112. FIG. 2A illustrates the locking element 110 in the first locking position 111;

FIG. 2B illustrates the locking element in the second locking position 112.

The indicator element 120 having the identifying feature 200 (see FIGS. 2A and 2B) serves to indicate an item of information, for example an item of information about the locking by the locking element 110. FIGS. 2A and 2B illustrate the identifying feature as a two-dimensional code with white and black elements or pixels. The 2D code is, for example, a DMC.

As already described above in relation to FIG. 1, the identifying feature 200 is visible within a first field of view 212 in the first locking position 111 of the locking element 110. When the identifying feature 200 is viewed from a second field of view 214, for example from above, as illustrated in FIG. 2A, the identifying feature 200 is not discernible.

In the second locking position 112 of the locking element 110, by contrast, the identifying feature 200 is visible within the second field of view 214. When the identifying feature 200 is viewed from the second field of view 214, for example from above, as illustrated in FIG. 2B, the identifying feature 200 is discernible.

What is important here is the property of the identifying feature 200 that, in both of the locking positions 111, 112 of the locking element 110, the identifying feature 200 is not concealed and remains visible.

The first field of view 212 and the second field of view 214 may include different viewing areas. FIGS. 2A and 2B illustrate a view of the identifying feature 200 from the second field of view 214. Therefore, in FIG. 2A, only a part, which cannot be scanned or discerned in this second field of view 214, of the identifying feature 200 is discernible. When the locking element 110 or the CPA system is closed, or when the locking element 110 is in the second locking position 112, the identifying feature 200 may be discerned and scanned in the second field of view 214. The item of information can then be read and it is discerned that the locking element 10 or the CPA system is closed.

The securing device 100 may include a manipulation element 216, which is designed to change the first field of view 212 to the second field of view 214 when the locking element 110 is being moved from the first locking position 111 to the second locking position 112.

The manipulation element 216 may, as illustrated in FIGS. 2A and 2B, be a wedge-like element, which, in the first locking position 111 as illustrated in FIG. 2A in a view from above, slides between the identifying feature 200 and the viewer so that the viewer can no longer fully discern the identifying feature 200 within the second field of view 214. By sliding in between the identifying feature 200 and the viewer, however, the manipulation element 216 creates a different field of view, specifically the first field of view 212, via which the identifying feature 200 is completely discernible. If the viewer thus moves away from the second field of view 214 to the first field of view 212, they can discern the identifying feature 200. However, they are then no longer looking at the identifying feature 200 from above, but rather viewing the identifying feature 200 from the side.

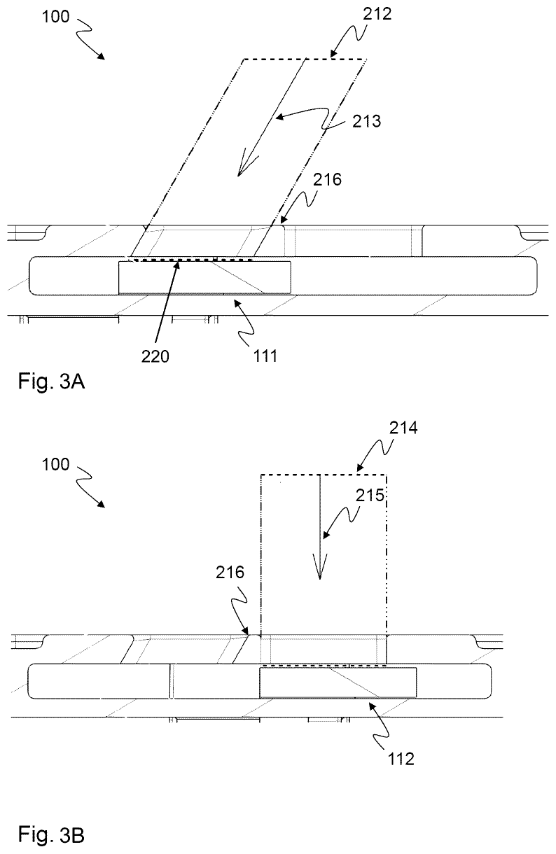

The manipulation element 216 may be designed to modify a reading direction 213, in which the identifying feature 200 can be discerned, when the locking element 110 is being moved from the first locking position 111 to the second locking position 112, as set out in more detail in relation to FIGS. 3A and 3B. As described above, the viewer may then change their viewing direction to be able to discern the identifying feature 200 in the new reading direction.

The identifying feature 200 may include a code 201, for example a 2-dimensional code such as a QR code, barcode or DMC, which is designed to indicate information.

The code 201 is discernible within the first field of view 212 in the first locking position 111 and is discernible within the second field of view 214 in the second locking position 112.

As depicted in the example of FIGS. 2A and 2B, the identifying feature 200 or the 2D code 201 may include a data matrix code, DMC, 201. This may, for example, also be a barcode.

Such a data matrix code includes or consists, for example, of the following main components:
1) two pairs of solid continuous edges and interrupted edges as boundary lines (finder pattern or position marker). The solid boundary lines serve for delimitation. They are used to align and equalize the data matrix code, so that any reading angle is possible.
2) a peripheral quiet zone. This empty zone surrounds the data matrix code. It does not contain any information or patterns. The width of the quiet zone is at least one gap or line (in one example four times the width, or height, of a module) and is desired for delimitation from other optical image elements of the surrounding area.
3) the corner situated opposite the closed edges. This corner makes it possible to quickly discern the code schemata. In the case of the identifying feature 200 being a code scheme ECC, with an even number of lines and gaps, the element in the upper right-hand corner is white. In the case of the other standardized code schemata, with an odd number of lines and gaps, the element in the upper right-hand corner is black.
4) the alignment pattern. This combination in pairs of continuous and interrupted lines in both directions, horizontally and vertically, makes it easier to evaluate the image. They subdivide large data fields into equally sized parts in the case of codes with an edge length of at least 32 modules.
5) the data area. This data area contains the actual binary information in coded form. Depending on the size of the matrix, the number of possible items of information is also defined in this way.

FIGS. 3A and 3B show an illustration of a further example of the securing device 100 in the first locking position 111, in which the identifying feature 200 is discernible in the first field of view 212 (FIG. 3A), and in the second locking position 112, in which the identifying feature 200 is discernible in the second field of view 214 (FIG. 3B).

FIGS. 3A and 3B show the same principle, as set out above in relation to FIGS. 2A and 2B, but in a sectional illustration from the side, in which the two fields of view 212, 214 are illustrated schematically.

As already described above, the securing device 100 serves to secure the locking of a locking element 110. The securing device 100 includes a locking element 110 and an indicator element 120 having an identifying feature 200, which is visible within the first field of view 212 or within the second field of view 214 depending on the locking position.

As already described above in relation to FIGS. 2A and 2B, the identifying feature 200 is visible within a first field of view 212 in the first locking position 111 of the locking element 110 (see FIG. 3A). When the identifying feature 200 is viewed from a second field of view 214, by contrast, the identifying feature 200 is not discernible in the first locking position 111 illustrated here.

In the second locking position 112 of the locking element 110 (see FIG. 3B), by contrast, the identifying feature 200 is visible within the second field of view 214. When the identifying feature 200 is viewed from the second field of view 214, for example from above, as illustrated in FIG. 3B, the identifying feature 200 is discernible.

The indicator element 120 includes an indication plane 220 and is designed to depict the identifying feature 200 on the indication plane 220.

The identifying feature 200 is discernible within a first range of reading angles to the indication plane 220 in the first locking position 111. FIG. 3A illustrates a first reading angle, or a first reading direction 213, within which the identifying feature 200 is discernible. It goes without saying that this is not just a single reading angle, but a range of different reading angles close to one another and corresponding reading directions.

However, the first range of reading angles does not include a right angle to the indication plane 220. That is to say, the identifying feature 200 is not discernible from above, which is to say at right angles to the indication plane 220.

The identifying feature 200 is discernible within a second range of reading angles to the indication plane 220 in the second locking position 112, as illustrated in FIG. 3B. The second range of reading angles includes a right angle to the indication plane 220, i.e. a reading direction 215 from above.

FIG. 3B illustrates a second reading angle, or a second reading direction 215, within which the identifying feature 200 is discernible. It goes without saying that this is not just a single reading angle, but a range of different reading angles close to one another and corresponding reading directions. This range includes a right angle to the indication plane 220, i.e. the identifying feature 200 is discernible from above.

In one example, the first range of reading angles and the second range of reading angles do not include a common angle. They are thus disjoint ranges. In an alternative example, the first range of reading angles and the second range of reading angles may partially overlap, although the right angle to the indication plane 220 only appears within the second range of reading angles.

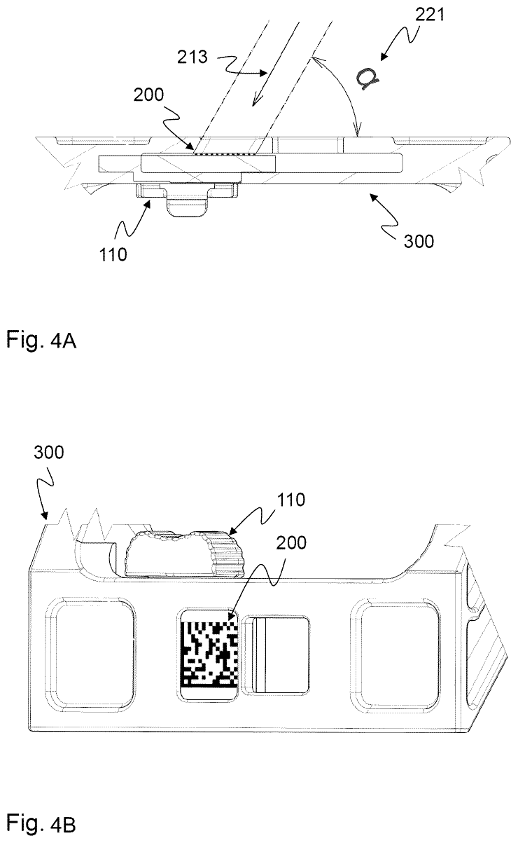

FIGS. 4A and 4B show a sectional illustration of the securing device 100 according to the present disclosure as per one example in the first locking position 111 at a reading angle 221 of approximately 70° (FIG. 4A) and a three-dimensional illustration of the securing device 100 according to the present disclosure looking towards the identifying feature parallel to the reading direction (FIG. 4B).

The securing device 100 corresponds to the securing devices described above in relation to FIGS. 2A to 3B.

As already described above, the securing device 100 serves to secure the locking of a locking element 110. The securing device 100 includes a locking element 110 and an indicator element 120 having an identifying feature 200, which is visible within the first field of view 212 or within the second field of view 214 depending on the locking position.

FIGS. 4A and 4B each illustrate the locking element 110 or the open CPA system, i.e. in the first locking position 111. The identifying feature 200 or the distinguishing feature can be discerned only within the first field of view 212, in this case for example at a reading angle of 70°, but not when viewed within the second field of view 214, which is to say for example from above.

If the viewer looks at the identifying feature 200 or the distinguishing feature in the first reading direction 213, they cannot discern the identifying feature 200, as illustrated in FIG. 4B.

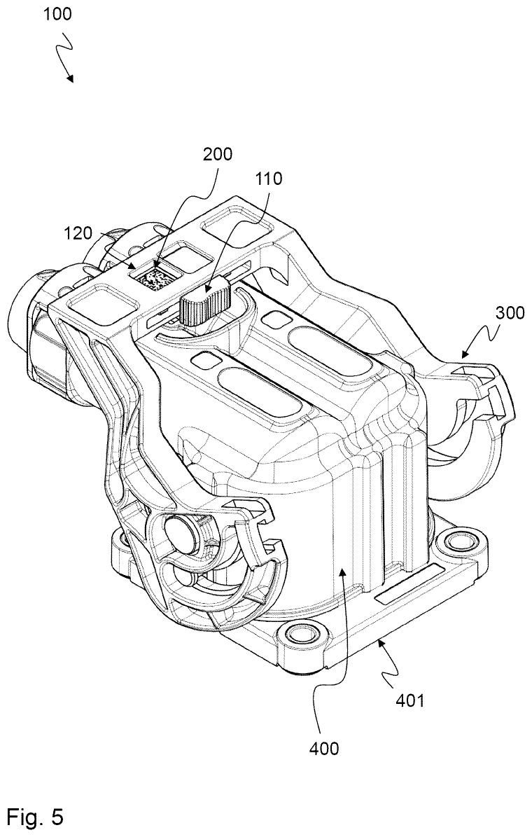

FIG. 5 shows a 3D illustration of a securing device 100 including a locking element 110, an indicator element 120 having an identifying feature 200 and a clamping element 300 in a closed clamping-clip position, in which the locking element 110 is in the second locking position 112.

The locking element 110 may be moved between the two locking positions 111, 112.

The securing device 100 is designed to perform connector position assurance (CPA) to secure the locking of a connector housing 400 to a mating connector housing 401, also referred to as interface.

In addition to the locking element 110 and indicator element 120 having an identifying feature 200 that are already described above, the securing device 100 also includes a clamping element 300, for example a clamping clip or clip, for clamping the connector housing 400 into the mating connector housing 401.

The clamping element 300 can be moved from an open clamping-element position, in which the connector housing 400 can be inserted into the mating connector housing 401, into a closed clamping-element position, in which the connector housing 400 is fastened to the mating connector housing 401 with electrical contact.

The locking element 110 is placed on the clamping element 300, as illustrated in FIG. 5, for example on a panel or a projection on the clamping element 300, as shown in FIG. 5, and is designed to lock or to unlock the clamping element 300.

The identifying feature 200 of the indicator element 120 indicates an item of information, for example an item of information about the locking of the clamping element 300 by the locking element 110. The identifying feature 200.

In the closed clamping-element position, the locking element 110 can be moved from the first locking position 111 into the second locking position 112. The locking element 110 is designed, in the second locking position 112, to lock the clamping element 300 in the closed clamping-element position and, in the first locking position 111, to unlock the clamping element 300 for a movement into the open clamping-element position.

The indicator element 120 having the identifying feature 200 is placed on the clamping element 300, for example on a panel on the clamping element 300, as illustrated in FIG. 5.

In the first locking position 111, the identifying feature 200 is visible within a first field of view 212, as described above in relation to FIGS. 2A to 4B. In the second locking position 112, the identifying feature 200 is visible within a second field of view 214, as described above in relation to FIGS. 2A to 4B.

FIG. 5 thus also shows a plug connection having a connector housing 400 and a mating connector housing 401, which are connected to one another and secured by the securing device 100 as described above.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A securing device for securing a lock of a locking element, comprising:
the locking element configured to move from a first locking position into a second locking position, the locking element configured to lock in the second locking position;
an indicator element including an identifying feature configured to indicate an item of information, the identifying feature is visible within a first field of view in the first locking position of the locking element, and in the second locking position of the locking element, the identifying feature is visible within a second field of view.

2. The securing device according to claim 1, wherein, in both the first locking position and the second locking position of the locking element, the identifying feature is not concealed and remains visible.

3. The securing device according to claim 1, wherein the first field of view and the second field of view includes different viewing areas.

4. The securing device according to claim 1, further comprising a manipulation element configured to change the first field of view to the second field of view when the locking element is moved from the first locking position to the second locking position.

5. The securing device according to claim 4, wherein the manipulation element is configured to modify a reading direction such that the identifying feature is discernible when the locking element is moved from the first locking position to the second locking position.

6. The securing device according to claim 4, wherein the indicator element includes an indication plane and is configured to depict the identifying feature on the indication plane, the identifying feature is discernible within a first range of reading angles with respect to the indication plane in the first locking position and the first range of reading angles does not include a right angle to the indication plane.

7. The securing device according to claim 6, wherein the identifying feature is discernible within a second range of reading angles with respect to the indication plane in the second locking position, and the second range of reading angles includes a right angle to the indication plane.

8. The securing device according to claim 7, wherein the first range of reading angles and the second range of reading angles do not include a common angle.

9. The securing device according to claim 4, wherein the identifying feature includes a code configured to indicate the item of information, the code is discernible within the first field of view in the first locking position, and the code is discernible within the second field of view in the second locking position.

10. The securing device according to claim 4, wherein the securing device is configured to perform connector position assurance (CPA) to secure a lock between a connector housing and a mating connector housing.

11. The securing device according to claim 10, further comprising:
a clamping element configured to clamp the connector housing into the mating connector housing, the clamping element configured to move from an open clamping-element position, in which the connector housing is configured to be inserted into the mating connector housing, into a closed clamping-element position, in which the connector housing is fastened to the mating connector housing with electrical contact; and
wherein the locking element is placed on the clamping element and configured to lock or to unlock the clamping element.

12. The securing device according to claim 11, wherein, in the closed clamping-element position, the locking element is configured to move from the first locking position into the second locking position, the locking element is configured, in the second locking position, to lock the clamping element in the closed clamping-element position and in the first locking position, to unlock the clamping element for movement into the open clamping-element position.

13. The securing device according to claim 11, wherein the indicator element and the manipulation element are placed on the clamping element.
